(19) United States
(12) Patent Application Publication
(10) Pub. No.: US 2008/0088193 A1
(43) Pub. Date: Apr. 17, 2008

(54) Rotor for a Permanent-Magnet Machine

(75) Inventor: Jouni Tervaskanto, Helsinki (FI)

Correspondence Address: BUCHANAN, INGERSOLL & ROONEY PC, POST OFFICE BOX 1404, ALEXANDRIA, VA, 22313-1404, US

(73) Assignee: ABB OY, Helsinki (FI)

(21) Appl. No.: 11/793,488

(22) PCT Filed: Dec. 23, 2005
(86) PCT No.: PCT/FI05/00549

§ 371 Date: Jul. 6, 2007

(30) Foreign Application Priority Data
Dec. 23, 2004 (FI) 20041666

(51) Int. Cl. H02K 1/28; H02K 1/27

(52) U.S. Cl. 310/156.22; 310/156.08

(57) ABSTRACT

The object of the invention is a rotor for a permanent-magnet machine including a rotor body structure. Magnetising means formed from permanent magnets are fastened to the rotor's body structure and are used to create two or more poles spaced at essentially equal distances in the circumferential direction of the rotor. According to the invention, each pole is implemented using two or more partial poles magnetised in the same direction. The partial poles are arranged sequentially in the circumferential direction of the rotor, and the adjacent partial poles of each pole are located at a distance from each other. The pieces of permanent magnets are fastened onto the rotor using fastening means fitted at least between two adjacent partial poles.

The object of the invention is a rotor according to the preamble part of claim 1.

Many different structures have been proposed for the rotor of a permanent-magnet synchronous machine, including magnets fitted onto the rotor surface and magnets embedded in the sheet core of the rotor. Important criteria affecting the choice of permanent magnets and rotor construction include the machine's electromagnetic properties and mechanical forces. In the case of small machines in which the masses involved are small and the circumferential rotor speed is low, the design can focus on ensuring sufficient excitation and an even distribution of magnetic flux in the air gap. As the size of the machine and the circumferential speed increase, mechanical stresses become more important.

There are prior art surface magnet solutions in which the magnets are fitted onto the circumferential surface of the rotor by glue or screws. The fastening of the magnets may be secured by a clamping band fitted around the magnets. For example, a band-type fastening solution is described in the publication EP0410048. There is a thin sheet around the permanent magnets and it is fastened to the rotor body between the poles. A solution in which the permanent magnets are fastened onto the rotor surface by a special shell structure is described in the publication WO02103882.

A structure in which the permanent magnets are circumferentially embedded in the rotor is described in the publication EP1420501. When the speed increases, the centrifugal force and the shearing force imposed on the rotor neck at the outer circumference become too strong.

In machines based on flux centering, such as solutions in which the permanent magnets are in a V arrangement on the sides of the magnetic poles, the centrifugal force imposed on the V piece is so strong that it cannot be implemented in large machines.

When the circumferential speed of the rotor is high, special attention must be paid to the fastening and securing of the permanent magnets. On the other hand, as the diameter of the machine increases, the pole becomes wider in the tangential direction. In a four-pole machine with a rotor diameter of one metre, the width of the pole is almost one metre. For example, if a four- or six-pole machine has a rotational speed of more than 1,500 RPM, a power rating of more than 15 MW and a body size of more than 1,000 mm, the circumferential speed is so high that great forces are imposed on the pole structures, including the magnets.

The objective of the invention is to create a new type of permanent-magnet rotor in which the prior art problems described above are eliminated and which is able to endure the stresses imposed on the permanent-magnet pieces and the components holding them in place. In order to achieve this, the invention is characterised by the features specified in the characteristics section of claim 1. Some other preferred embodiments of the invention have the characteristics specified in the dependent claims.

A solution according to the invention creates an optimally distributed air gap flux in the machine's air gap that fulfils the dimensioning requirements at idle and under load. The invention also makes it possible to employ dimensioning principles and structural solutions that have proven to be good in electrical machine design. Advantageous distribution of total flux can be ensured by shaping the air gap in a suitably curvilinear form. Furthermore, it is simple to make the poles oblique so that the magnets are not exactly parallel to the axial line of the machine and use offset so that the distribution of the magnets in the circumferential direction is not exactly even. According to the invention, the magnets of the partial poles are fastened to the rotor body. As the mass of the permanent motor is lower, the force imposed on the fastening component or element is smaller. This means that the mechanical attachment is easier to make and more reliable.

According to an embodiment of the invention, the permanent magnets of the partial poles are fastened using a shell structure fitted onto them. The structure can be dimensioned and shaped as required by the permanent-magnet pieces. Bolting each shell structure to the rotor separately on the side of each partial pole ensures that the permanent magnets are reliably fastened.

According to an embodiment of the invention, a pole piece made of magnetically conductive material and designed to make the shape of the rotor's outer circumference and the distribution of magnetic flux in the air gap advantageous is arranged on the partial pole's permanent-magnet piece.

According to another preferred embodiment, magnetically conductive material, such as a magnetic groove stick, is fitted between the partial poles and assists in keeping the air gap flux symmetrical even when the machine is under load.

In the following, the invention will be described in detail by referring to the drawings, where:

FIG. 1 illustrates a partial cross section of a rotor according to the invention, and

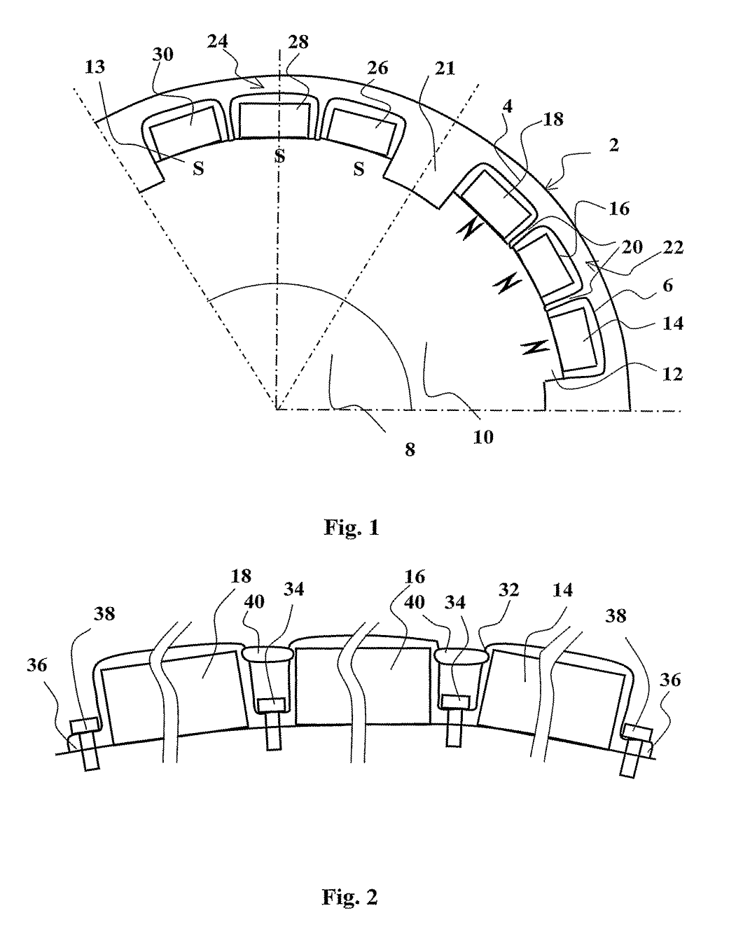

FIG. 2 illustrates the details of a pole structure according to the invention and the fastening of the permanent magnets, and

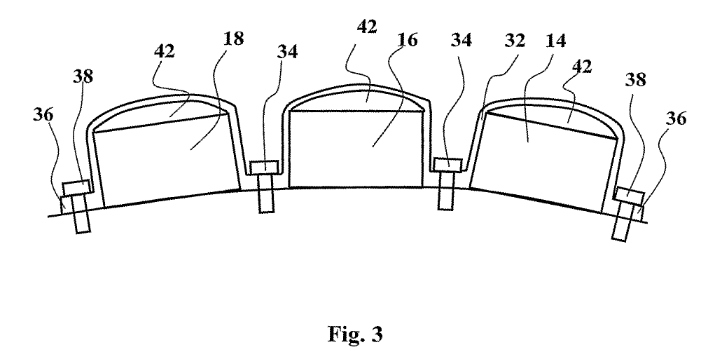

FIG. 3 illustrates another pole structure according to the invention.

FIG. 1 illustrates the principal structure of a rotor according to the invention, including two poles of a six-pole rotor. The only part of the stator visible in the illustration is the inner circumference 2 with an air gap 4 between it and the outermost part of the outer circumference of the rotor 6. The rotor 6 comprises a sheet pack 10 assembled from a material such as magnetically conductive sheets, and fitted on the shaft 8. The sheets in the pack have been cut to create an essentially cylindrical sheet body. There are projections 12 and 13 in the body at the locations of the poles. This means that in the area 21 between the poles, the rotor is thinner and the gap between the rotor and stator is clearly larger than the machine's air gap 4. There are three permanent magnets 14, 16 and 18 fitted on the rotor projection 12 spaced at a small distance 20 from each other in the circumferential direction of the rotor, creating the partial poles of the pole 22. The permanent magnets can be manufactured from several adjacent permanent-magnet pieces in the longitudinal direction of the machine. In the circumferential direction, permanent magnets separate from each other are magnetised in the same direction, so within the pole 22, all of the permanent magnets 14, 16 and 18 have their N poles facing the air gap. Correspondingly, the partial poles 26, 28 and 30 within the pole 24 have their S poles facing the air gap. As is schematically illustrated in FIG. 1, all of the partial poles are covered by a shell structure 32 that is fastened onto the rotor body at the edges of the partial poles. The shell structure is implemented as described in the application WO02103882, for example. The shape and dimensions of the shell structure are such that the centrifugal forces imposed on the permanent magnets during rotation can be controlled. As each magnet in the circumferential direction of the rotor is separately fastened so that there is a fastening element on both sides of each partial pole, the magnets can be held reliably in place. In high-speed machines, the effect of shear stress is strongest at the corner of the partial pole. The adverse effect of this stress is preferably reduced by malting the shell structure stronger and chamfering the corners of the permanent magnets by grinding.

FIG. 2 is a more detailed illustration of the fastening arrangements for the shell structure and permanent magnets. In the illustration, the relative distance between the partial poles is substantially large. Fastening bolts 34 for the shell structure 32 holding the permanent magnets are fitted between the partial poles 14, 16 and 18. In the circumferential direction on the sides of the pole, the shell structure 32 extends slightly outside the outermost partial poles 14 and 18. The attachment of each partial pole can equally well be implemented using separate shell structures, in which case the edges of the shell structure between the partial poles are attached by shared fastening bolts. Fastening bolts 38 are correspondingly fitted into the edge parts 36 of the shell structure 32. The shell structure is manufactured from a material such as carbon fibre, as described in the application WO02103882. The gaps 20 between the partial poles are open and only contain the fastening bolts 34. The gaps are as narrow as possible to prevent the magnetic fluxes of the partial poles from leaking into the area of the adjacent partial pole under load.

The shell structure is attached onto the surface of the rotor body on both sides of each partial pole. Each pole has fastening bolts on both edges and between each adjacent partial pole. Thus four bolts in the cirumferential direction fasten a pole with three partial poles. Respectively in the case of two partial poles there are three fastening bolts and in the case of four partial poles there are five fastening bolts in the circumferential direction.

Alternatively, the fastening bolts are located so that there are only three bolts in a circumferential line. Two bolts are located on the edges of the pole and one bolt is located between the first and second partial pole, whereas there is no bolt between the second and the third partial pole. Instead in the next circumferential fastening line there is fastening bolt between the second and the third partial pole and there is no bolt between the first and second partial pole. The distance between the fastening bolts is so small that the centrifugal forces are duly controlled. The location of the fastening bolts may vary case by case depending on the circumferential speed of the rotor, on the mass and the form of the permanent magnet pieces and on the characteristics of the shell structure.

In order to maintain the best possible symmetry of the magnetic field created jointly by the partial poles under load, additional magnetic groove sticks 40 can be fitted between the partial poles. The groove sticks extend axially from one end of the rotor to another.

The curvilinear shape of the outer surface of the rotor improves the distribution of the air gap flux and therefore enhances the machine's properties, as is well known. The pole projections in the rotor body are preferably cut so that the magnets are in the correct position relative to the machine's air gap. Furthermore, the shape of the rotor's outer circumference is made advantageous by adding a magnetically conductive layer between the permanent magnets and the shell structure. In the example of FIG. 3, a pole piece 42 manufactured from a material such as Somaloid is fitted on the partial poles 14, 16 and 18.

In the above, the rotor is represented as a self-contained structure in which the entire part between the shaft and the poles consists of a uniform sheet pack. The invention can equally well be applied to other types of rotor body structures. The rotor may have openings in the axial direction to make it lighter and enable the circulation of cooling air. Furthermore, the shaft and rotor body can consist of a single forged and machined piece.

In the above, the invention has been described with the details of certain embodiments. However, the description should not restrict the scope of patent protection, but the scope may vary within the framework of the definitions in the claims.

1. A rotor for a permanent-magnet machine including a body structure and magnetising means formed from pieces of permanent magnets which are fastened to the rotor's body structure and are used to create two or more poles spaced at essentially equal distances in the circumferential direction of the rotor, wherein each of the poles is implemented using two or more partial poles magnetised in the same direction; the partial poles of each pole are arranged sequentially in the circumferential direction of the rotor, and the adjacent partial poles of each pole are located at a distance from each other, and that the pieces of permanent magnets are fastened onto the rotor using fastening means fitted at least between two adjacent partial poles.

2. A rotor according to claim 1, wherein a shell structure is formed on the partial pole.

3. (canceled)

4. A rotor according to claim 1, wherein the fastening means is non-magnetic.

5. A rotor according to claim 1, wherein a pole piece is arranged on the partial pole.

6. A rotor according to claim 5, wherein the outer surface of the pole piece is shaped so that the radius of the pole piece is smaller than the radius of the stator towards the air gap.

7. A rotor according to claim 1, wherein magnetically conductive material such as a groove stick is fitted between the partial poles.

8. A rotor according to claim 1, wherein there is an opening between the adjacent poles that is essentially equal in depth to the permanent-magnet piece in the radial direction of the rotor.

9. A rotor according to claim 1, wherein the fastening means are fitted on both sides of each partial pole.
